(19) United States
(12) Patent Application Publication
(10) Pub. No.: US 2020/0157845 A1
(43) Pub. Date: May 21, 2020

(54) REMOTELY CONTROLLABLE SECURITY BAR

(71) Applicant: Harrison Edgley, Upper Marlboro, MD (US)

(72) Inventor: Harrison Edgley, Upper Marlboro, MD (US)

(21) Appl. No.: 16/687,948

(22) Filed: Nov. 19, 2019

Related U.S. Application Data
(60) Provisional application No. 62/769,607, filed on Nov. 20, 2018.

(51) Int. Cl. E05B 47/00; E05B 47/02

(52) U.S. Cl. CPC E05B 47/0004; E05B 2047/0094; E05B 47/023; E05B 47/0012

(57) ABSTRACT

A security bar for doors and windows is disclosed. The security bar includes a expandable housing and a locking assembly. The expandable housing is movable between a contracted position and expanded position. The locking assembly is remotely actuatable and is disposed within the expandable housing. The locking assembly is also configured to unlock the expandable housing from the expanded position in response to a remote actuation.

### CROSS-REFERENCE TO RELATED APPLICATIONS

This application claims priority to and is based on U.S. Patent Application No. 62/769,607, filed Nov. 20, 2018, and entitled “Remotely Controllable Security Bar,” the entire contents of which are incorporated by reference herein.

### FIELD OF INVENTION

The present invention relates to security bars and, in particular, security bars suitable for doors and windows, such as security bars for preventing access through a sliding door.

### BACKGROUND

Home security is and has been a major concern for many people. Consequently, home alarm systems, deadbolt locks, and other security products are widely prevalent in many homes. Unfortunately, the security options for sliding doors and windows that slide open are often limited and the locks often implemented with these doors and windows may not be as strong as locks often implemented for doors that pivot open (which are lockable via deadbolts and other relatively strong locks). Thus, in some instances, a person may use a security bar (also referred to as a locking bar) for a sliding door or window. Unfortunately, typically, these security bars are only installable from an inside of the home. For example, a rigid locking bar (e.g., a solid rod made of metal, wood, etc. that is laid in the tracks of a sliding door) installed on the inside of a door cannot be opened from the outside of the door by anyone, including the resident of the home (e.g., the homeowner, renter, occupant, etc.). Thus, a person may be unable to use a security bar when they are traveling outside of their home (since the security bar is un-installable and inaccessible from the exterior of the door).

To solve this issue, some remote-controlled security bars have been introduced to the market. However, these remote-controlled security bars are typically large, expensive, and difficult to install on a door or window. Moreover, many of these remote-controlled security bars include components that pivot or rotate with respect to each other and, thus, may create or define areas that form a clamp or vice as the security bar moves between locked and unlocked positions. This may be especially detrimental for a security bar, since security bars may often be used for childproofing a home in addition to security purposes. Moreover, pivoting or rotating components may require regular maintenance, which may be difficult and/or expensive. In view of at least the aforementioned issues, improved security bars are desired.

### SUMMARY

The present invention relates to a security bar (also referred to as a locking bar). The security bar includes a expandable housing and a locking assembly. The expandable housing is movable between a contracted position and expanded position. The locking assembly is remotely actuatable and is disposed within the expandable housing. The locking assembly is also configured to unlock the expandable housing from the expanded position in response to a remote actuation. Alternatively, the locking assembly may be configured to lock the expandable housing in the expanded position in response to a remote actuation.

In at least some embodiments, the locking assembly is disposed entirely within the expandable housing. Additionally or alternatively, the expandable housing may be telescopic and may include a central segment, a first end segment disposed on a first side of the central segment, and a second end segment disposed on a second side of the central segment. In at least some of these embodiments, the first end segment and the second end segment are movable over an exterior of the central segment. Additionally or alternatively, the locking assembly may be disposed within the central segment.

In some embodiments, the expandable housing can span a window frame or door frame when in the expanded position. Additionally or alternatively, the locking assembly may include a locking mechanism, a control module, and an actuator that is configured to actuate the locking mechanism from a rest or biased position to an actuated position when the control module receives a command to lock or unlock the security bar.

According to another embodiment, the present application is directed to a window assembly including a window frame, a first window that is movable within the window frame, a second window that is movable within the window frame, and a security bar. The security bad extends linearly over the first window, between the second window and the window frame, and is remotely actuatable to lock or unlock the second window for linear movement within the window frame. The security bar moves linearly to extend or collapse as the second window moves within the window frame.

According to yet another embodiment, the present application is directed to a door assembly including a door frame, a first door that is movable within the door frame, a second door that is movable within the door frame, and a security bar. The security bad extends linearly over the first door, between the second door and the door frame, and is remotely actuatable to lock or unlock the second door for linear movement within the door frame. The security bar moves linearly to extend or collapse as the second door moves within the door frame.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1 is a front perspective view of an example remotely controllable security bar in accordance with an example embodiment of the present invention, with the security bar shown in an expanded position.

FIG. 2 is a front perspective view of the remotely controllable security bar of FIG. 1, with the security bar shown in a contracted position.

FIG. 3 is a partially exploded view of the remotely controllable security bar of FIG. 1.

FIGS. 4A and 4B depict an interior of a sliding door assembly and an interior of a window assembly, respectively, that include the remotely controllable security bar of FIG. 1.

FIG. 5 is a sectional view of the remotely controllable security bar of FIG. 1, illustrating a locking assembly included in the security bar while in a locked position.

FIG. 6 is a sectional view of the remotely controllable security bar of FIG. 1, illustrating the locking assembly in an unlocked position.

FIG. 7 is a block diagram of a control module included in the remotely controllable security bar of FIG. 1.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

Generally, the remotely controllable security bar provided herein is a telescopic security bar with a locking assembly that is remotely actuatable (i.e., remotely controllable). The locking assembly is disposed within a telescopic housing and is actuatable via a remote control. Thus, the security bar presented herein can be unlocked (or locked) from inside or outside of a residence. The telescopic housing allows the security bar to easily expand or contract to fit doors and windows of various dimensions and can be easily installed without damaging a door frame, window frame, etc. In fact, in at least some embodiments, the security bar can be installed without any tools. For example, the security bar can be affixed to a door or window frame with tension and/or friction.

Moreover, the telescopic housing substantially encloses the locking assembly so that the locking assembly does not create safety hazards. For example, since the locking assembly is disposed within the housing of the security bar, a child cannot access the locking assembly. Moreover, since the locking assembly is disposed within the telescopic housing, external components of the security bar do not rotate to constrict or close spaces or areas around or between components of the security bar as the security bar moves between locked and unlocked positions. Thus, the security bar provided herein is unlikely to clamp on a user's hand, arm, toe, foot, etc. or otherwise serve as a safety hazard for users, infants, or toddlers.

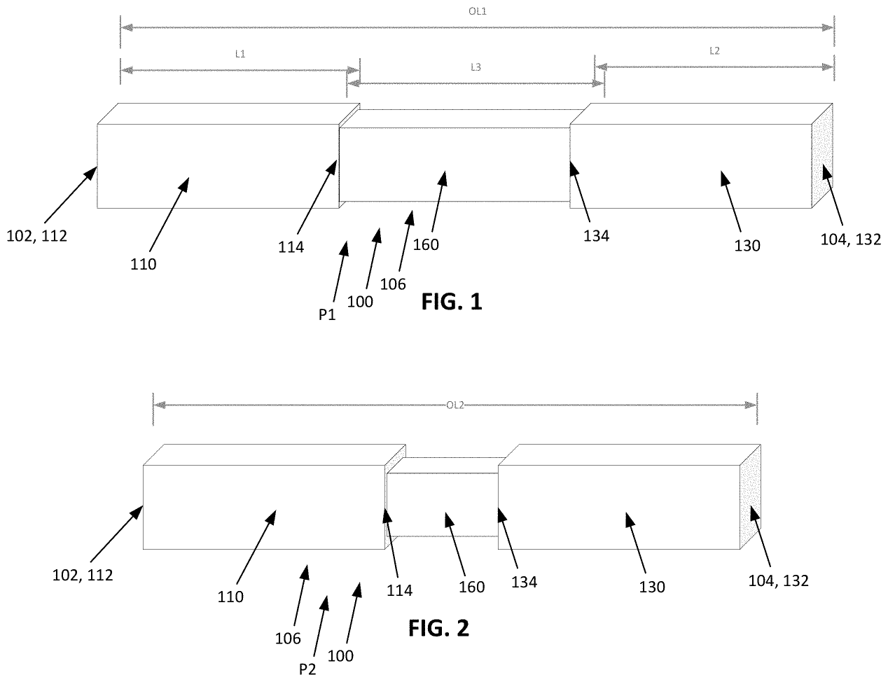

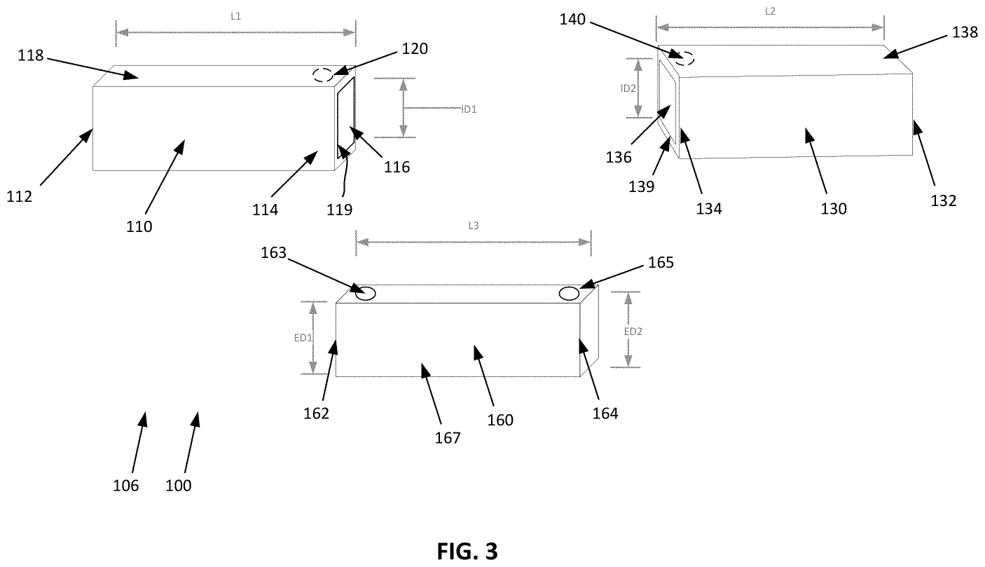

FIGS. 1 and 2 illustrate one example embodiment of a security bar 100. Overall, the security bar 100 is formed from a telescopic housing 106 that can expand and contract in any manner now known or developed hereafter. For example, the telescopic housing 106 may expand and contract when various segments move inwardly or outwardly from adjacent segments. In the depicted embodiment, the telescopic housing 106 includes three segments: a first end segment 110, a second end segment 130, and a central segment 160. However, in other embodiments, the telescopic housing 106 may include any number of segments arranged in any manner.

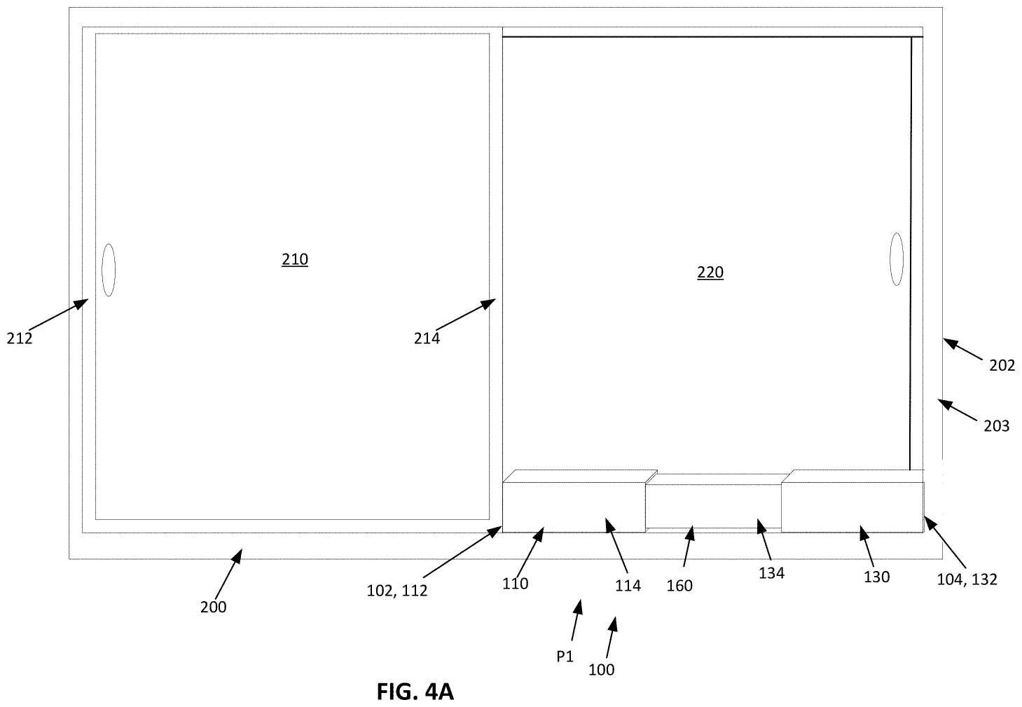

In the depicted embodiment, the first end segment 110 (also referred to herein as segment 110, first segment 110, end segment 110, and other variations thereof) extends from a first end 112 to a second end 114 and the second end segment 130 (also referred to herein as segment 130, second segment 130, end segment 130, and other variations thereof) extends from a first end 132 to a second end 134. The first end 112 of segment 110 defines a first end 102 of the telescopic housing 106 and the first end 132 of segment 130 defines a second end 104 of the telescopic housing 106. Meanwhile, the second ends 114, 134 of the first end segment 110 and the second end segment 130 are movably coupled to end 162 and end 164 (see FIG. 3) of the central segment 160 (also referred to herein as segment 160 and other variations thereof), respectively. Thus, in the expanded position P1, the security bar 100 has an overall length “OL1” that is slightly less than the sum of the lengths “L1,” “L2,” and “L3” of segments 110, 130, and 160, respectively. By comparison, in a contracted position P2, end segments 110 and 130 overlap at least a portion of the length L3 of the central segment 160 so that the security bar 100 has an overall length “OL2” that is smaller than length OL1.

Still referring to FIGS. 1 and 2, but now with reference to FIG. 3 as well, in the depicted embodiment, each of the segments has a square external cross-sectional shape. That is, the first segment 110 has an exterior 118 that is substantially cuboidal except that the first end segment 110 includes an opening 116 at its second end. Similarly, the second segment 130 has an exterior 138 that is substantially cuboidal, except that the second end segment 130 includes an opening 136 at its second end 134. Openings 116 and 136 allow the first end segment 110 and the second end segment 130 to slide over an exterior 167 of the central segment 160 (which is also substantially cuboidal in the depicted embodiment).

More specifically, in the depicted embodiment, the first end segment 110 and the second end segment 130 have square openings 116 and 136 sized to receive a central segment 160 with a square cross-sectional exterior 167. That is, opening 116 has interior dimensions “ID1” configured to receive and slide along exterior dimensions “ED1” of the first end 162 of the central segment 160 while opening 136 has interior dimensions “ID2” configured to receive and slide along exterior dimensions “ED2” of the second end 164 of the central segment 160 (notably, only heights are labelled in the drawings since the height and width of the squares are equal). In the depicted embodiment, the central segment 160 has a constant or uniform exterior 167 so that ED1 is equal to ED2. Additionally, ID1 and ID2 are equal, so that an interior 119 of the first end segment 110 and an interior 139 of the second end segment 130 may each move along the exterior 167 of the central segment 160 until the second end 114 of segment 110 meets the second end 134 of segment 130.

However, in other embodiments, the various segments and openings may have any shape or size. For example, the exterior 167 of the central segment 160 may be contoured to provide natural stops that restrict inward movement of end segment 110 and/or end segment 130 to a certain maximum limit. Additionally or alternatively, the central segment may include or be configured to receive stops to provide the same movement limitations. As yet another example, in some embodiments, end segments 110, 130 and/or central segment 160 and openings 116 and 136 may be cylindrical (so that, for example, dimensions ID1, ID2, ED1, and ED2 define diameters) or any other shape that allows the various segments to telescope (e.g., expand and contract with respect to each other). As still another example, one of segment 110 or segment 130 may have overall dimensions and an opening that are larger than the other (e.g., segment 130 may be larger than segment 110 and ID2 may be larger than ID1, or vice versa) so that segment 110 or 130 may be able to slide inside of the other when the telescopic housing 106 moves to its contracted position P2.

Regardless of how the telescopic housing 106 telescopes (e.g., expands and collapses/contracts), the telescopic housing 106 may move between the expanded position P1 to a contracted position P2. The contracted position P2 has an overall length “OL2” that is smaller than the expanded overall length OL1, insofar as the overall lengths OL1 and OL2 are defined by the dimension spanning from the first end 102 of the security bar 100 to the second end 104 of the security bar 100. For example, the contracted overall length OL2 may be substantially equivalent to the length of one of the end segments 110, 130 (e.g., in embodiments where end segment 110 nests within end segment 130 or vice versa) or substantially equivalent to the combined length of both end segment 110 and end segment 130 (e.g., in embodiments where segments 110 and 130 abut).

As a more specific example, in some embodiments, the security bar 100 (or more specifically, the telescopic housing 106) may have an overall length OL1 in the range of approximately 27-30 inches in the expanded position P1 and an overall length OL2 in the range of approximately 10-13 inches in the contracted position P2. Alternatively, the security bar 100 may have overall lengths OL1 and OL2 suitable for any desirable door or window, such as an overall length OL1 in the range of approximately 10-60 inches and an overall length OL2 in the range of approximately 6-45 inches, provided the contracted overall length OL2 is smaller than the expanded overall length OL1.

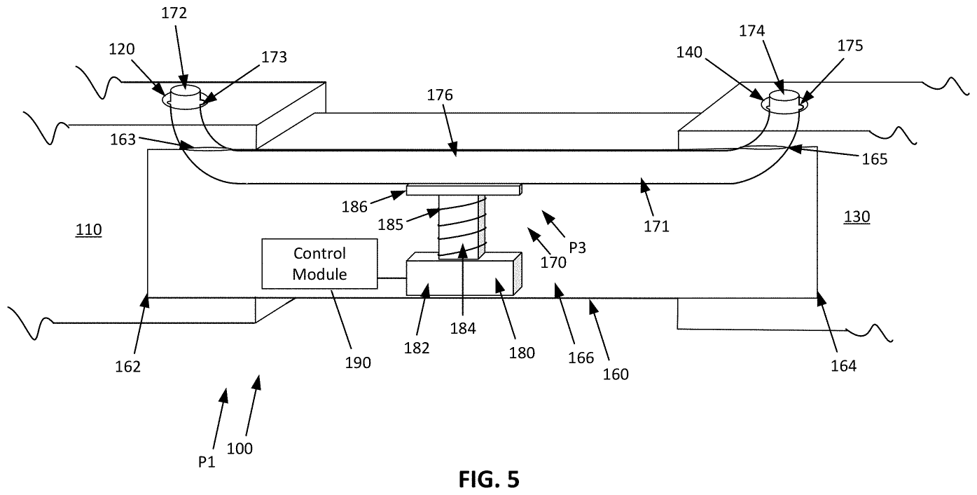

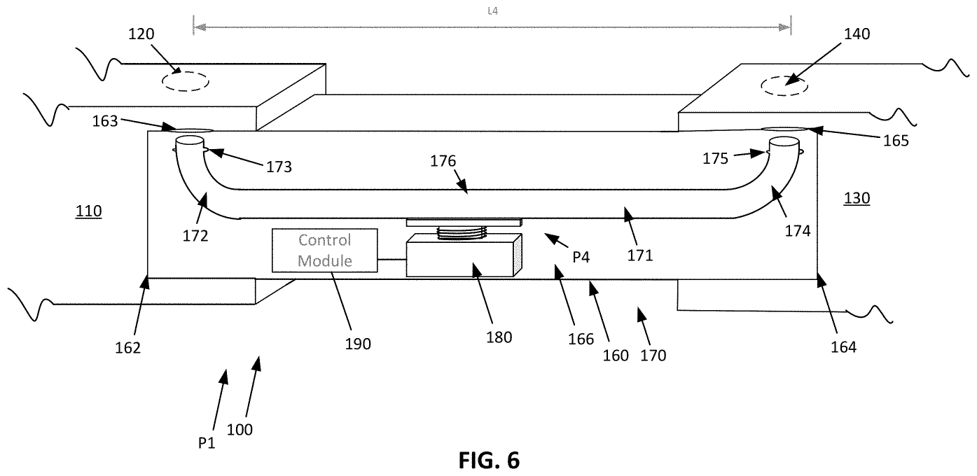

In the depicted embodiment, the contracted overall length OL2 is defined by the full lengths L1 and L2 of end segments 110 and 130 and a small portion of the length L3 of the central segment 160. That is, in the depicted embodiment, end segment 110 and end segment 130 do not come into contact with each other when the security bar 100 is in its collapsed position P2 (see FIG. 2). However, regardless of the specific overall length OL2 of the security bar 100 when it is in its contracted position P2, the segments 110, 130, and 160 may be secured in the contracted position P2 by a locking assembly 170 (see FIGS. 5 and 6). This locking assembly 170 may engage receivers/openings 120 and 140 included on the first segment 110 and second segment 130, respectively. Notably, in FIG. 3 (and in FIGS. 5-6 as well). receivers 120 and 140 are depicted with dashed lines. This is because the receiver/opening 120 may be included on the interior 119 and/or the exterior 118 of segment 110 and receiver/opening 140 may be included on the interior 139 and/or the exterior 138 of segment 130. That is, interiors 119/139 may define receivers 120/140 and/or receivers 120/140 may be or include through holes that extend through interiors 119/139 and exteriors 118/138.

Still referring to FIGS. 1-3, in some embodiments, the first segment 110, the second segment 130, and the central segment 160 may each move independently with respect to one another. Alternatively, the first end segment 110 and the second end segment 130 might be linked (e.g., via one or more racks and one or more pinions) so that segments 110 and 130 move together in synchronization as the telescopic housing 106 expands or contracts. Additionally or alternatively, the end segments may be biased towards either the expanded position P1 or the contracted position P2 (e.g., via one or more resilient members, such as one or more springs).

As one example, the first segment 110 and the second segment 130 may biased outwards with respect to the central segment 160. In at least some of these embodiments, the first end 102 (e.g., the first end 112 of segment 110) and the second end 104 (e.g., the first end 132 of segment 130) of the telescopic housing 106 may include grip members (e.g., rubber feet). The grip members may allow the outwardly biased telescopic housing 106 to be secured within a door or window frame in a similar manner to the manner in which a tension bar may be secured within a window or door frame. That being said, the first end 102 and the second end 104 of the telescopic housing 106 might also be or include grip members in other embodiments as well. Additionally or alternatively, in various embodiments, the first end 102 and the second end 104 of the telescopic housing 106 might include mounting features, mounting assemblies, installation features, or any other such components/features that allow the telescopic housing to be secured to opposite sides of a door or window frame. For example, ends 102 and 104 might include or be configured to receive mounting tape, mounting strips, etc.

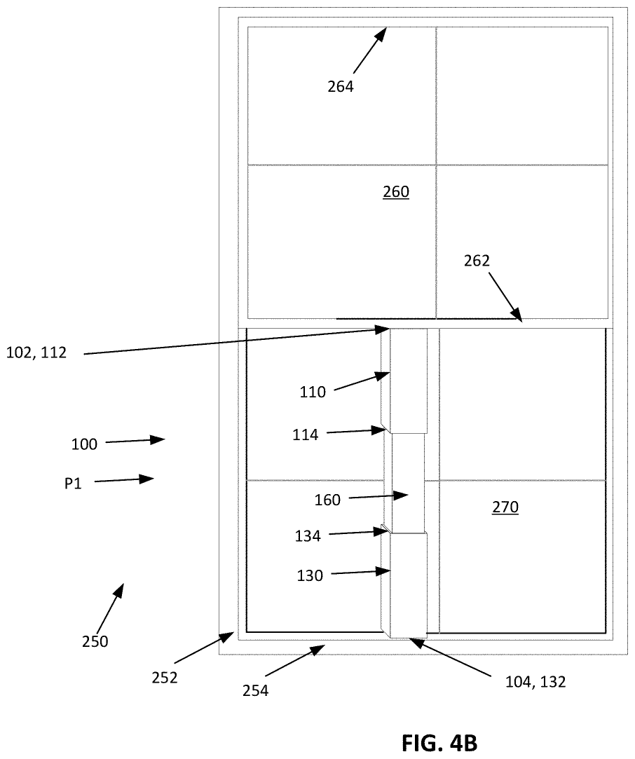

Now turning to FIGS. 4A and 4B, regardless of how segments 110, 130, and 160 move with respect to each other (or regardless of how any number of segments move with respect to each other), when the security bar 100 is installed as a security device for a door or window (or any other such use), the telescopic housing 106 will typically expand and contract as the door opens and closes. For example, if one end of the telescopic housing 106 (e.g., second end 104) is secured to a surface that is largely stationary surface or object, such as a door or window frame, and the other end (e.g., second end 104) of the telescopic housing 106 is secured to a sliding door, the telescopic housing 106 will expand and contract as the door closes and opens, respectively. Consequently, the security bar 100 will be in its extended position P1 when a door or window is closed, which may allow the security bar to be locked or unlocked via remote actuation as is described in detail below.

In FIG. 4A, the security bar is shown securing a sliding door and in FIG. 4B, the security bar 100 is shown securing a window. Each of these examples are addressed in turn below; however, it is to be understood these are merely examples and that the security bar 100 may be used to secure any apparatus that slides open.

In FIG. 4A, the security bar 100 is installed on sliding door assembly 200 that includes a first door 210 and a second door 220 that are each slidable within a door frame 202. The door assembly 200 is shown from an interior side (i.e., the portion of the door assembly 200 seen from within a residence is shown) and door 220 is positioned exteriorly of door 210. Thus, both a handle side 212 and a central side 214 of door 210 are visible, while a central side of door 220 is obscured behind door 210. When the security bar 100 is used with this door assembly 200, the first end 102 of the security bar 100 is secured to or affixed against the central side 214 of door 210 and the second end 104 of the security bar 100 is secured to or affixed against side 203 of the door frame 202 (e.g., the side of the door frame 202 closes to the handle side of door 220). Consequently, security bar extends substantially across the second door 220.

By comparison, in FIG. 4B, the security bar 100 is installed on a window assembly 250 that includes two windows that are slidable within a window frame 252: a first window 260 and a second window 270 that is positioned exteriorly of the first window 260. Like the door assembly 200 in FIG. 4A, the window assembly 250 is shown from an interior side (i.e., the portion of the window assembly 250 seen from within a residence is shown). Thus, both a bottom 262 and a top 264 of window 260 are visible, while a top of window 270 is obscured behind window 260. When the security bar 100 is used with this window assembly 250, the first end 102 of the security bar 100 is secured to or affixed against the bottom 262 of window 260 and the second end 104 of the security bar 100 is secured to or affixed against a bottom 254 of window frame 252. Consequently, security bar extends substantially across the second window 270.

In either of the configurations shown in FIGS. 4A and 4B, the security bar 100 may be secured to, coupled to, or affixed against the central side 214 of door 210, the side 203 of the door frame 202, the bottom 262 of window 260 and/or the bottom 254 of window frame 252 in any manner, such as via mounting components, removable mountings, fasteners, etc. Regardless, since the security bar is coupled to a fixed surface (e.g., door frame 202 and window frame 252) and a movable component (door 210 and window 260), the security bar 100 contracts towards its contracted position P2 when the door 210 or window 260 slides open. Then, as the door 210 or window 260 is closed, the security bar 100 expands back to its expanded position P1. As is described in further detail below, when the telescopic housing 106 is in its expanded position P1, the telescopic housing 106 may be able to be unlocked (or locked) via a remote actuation.

Notably, during these various expansions and contractions, no external parts (e.g., portions of the telescopic housing 106 that are visible or accessible from outside the telescopic housing 106) of the security bar 100 rotate or pivot with respect to any other component of the security bar 100. Thus, the security bar does not pose a risk of constriction. To the contrary, the security bar 100 is largely linear and extends directly across a window or door and, thus, is quite unobtrusive. In fact, in at least some embodiments, the security bar 100 may be aligned flush with a door or window frame, embedded therein, or sit within a track defined by a door or window frame so that the security bar 100 blends almost seamlessly with the aesthetic of a door or window frame. This may also allow various embodiments of the security bar to be used in various capacities.

For example, a security bar 100 that contracts into a small space might even be able to be installed between the handle side 212 of door 210 and the side of the door frame 202 adjacent the handle side 212 of door 210 (e.g., the side opposite side 203). This embodiment might ride in the track between the door frame 202 and the door 210 and contract into an opening provided in the door frame 202. However, since the security bar 100 only extends linearly, it would not create a tripping hazard (since it would not extend substantially above the tracks of the door frame 202), even when in its expanded position P1. Alternatively, the security bar 100 might be positioned adjacent a top of the door frame 202 and would not substantially decrease the height of the opening provided by the door frame 202 (if it impacts the height of the door opening at all).

Still referring to FIGS. 4A and 4B, as mentioned, in some embodiments, the various segments 110, 130, 160 of the security bar 100 may move independently. In these embodiments, as door 210 or window 260 opens, the first segment 110 may initially be the only segment that moves. Then, as the door 210 or window 260 continues to open, the first segment 110 may force the central segment 160 into the second end segment 130 to cause the telescopic housing to continue contracting or collapsing along the length of the security bar 100 (which, in the examples of FIGS. 4A and 4B, approximately spans the width of door 220 and the height of window 270, respectively). Alternatively, if end segments 110 and 130 are linked, opening the door 210 or window 260 may draw the central segment 160 into the second end segment 130 as the first end segment moves onto/over the central segment 160. Moreover, and was also mentioned above, in some embodiments, end segments 110 and 130 may be biased outwardly. In these embodiments, the biasing may cause the door 210 or window 260 to automatically shut (or at least automatically begin to shut) after it is opened.

Now turning to FIGS. 5 and 6, these figures illustrate partial sectional views of the security bar 100 that show an example embodiment of a locking assembly 170 in a rest or unactuated position P3 and an actuated position P4, respectively. Generally, the locking assembly 170 is included within an interior compartment 166 defined by the central segment 160 and includes a locking mechanism 171 (also referred to as locking bar 171, locking device 171, or variations thereof) that can be moved by an actuator 180 to: (a) unlock the security bar 100 from its extended position P1; and/or (b) lock the security bar 100 in its extended position P1. In the depicted embodiment, the actuator 180 biases the locking mechanism 171 towards a rest or unactuated position P3 (also referred to as a biased position P3) so that the security bar 100 is automatically locked in its extended position P1 once it is moved to its extended position P1. Then, the actuator 180 moves the locking mechanism 171 to an actuated position P4 to unlock the security bar 100 from its extended position P1. However, in other embodiments, the actuator 180 may move the locking mechanism 171 from its rest or unactuated position P3 to its actuated position P4 and/or from its actuated position P4 to its rest or unactuated position P3 (i.e., from any first position to any second position).

The actuator 180 may be fixedly coupled to the central segment 160 (e.g., to a side or bottom of the interior compartment 166) and also fixedly coupled to the locking mechanism/locking bar 171. For example, in the depicted embodiment, a bottom of the actuator 180 is fixedly coupled to a bottom of the central compartment and a top of the actuator 180 is fixedly coupled to a bottom of a central portion 176 of the locking mechanism/lock bar 171. The actuator 180 may be secured to the locking mechanism/lock bar 171 and/or the central segment 160 in any manner. For example, the actuator might be secured to the locking mechanism/lock bar via magnets, fasteners (e.g., screws), adhesives, and/or lashings extending around the lock bar 171 and an engagement end 186 (see FIG. 6) of the actuator. Additionally, the actuator 180 is operably connected to a control module 190 that can control the actuator 180 in response to signals from a remote electronic device (e.g., a smartphone, a remote control, home assistant device, or any other electronic device).

For example, in some embodiments, when the control module 190 receives a signal to unlock the security bar 100, the control module 190 may cause actuator 180 to move the locking assembly 170 into its actuated position P4 by moving the U-shaped locking bar 171 downwards, out of engagement with the first segment 110 and the second segment 130. Additionally or alternatively, in some embodiments, a lock signal may cause the actuator to move the U-shaped locking bar 171 into engagement with segments 110 and 130. Consequently, the security bar 100 can be remotely unlocked (or locked) from the interior or exterior of a residence (e.g., from outside of the door assembly 200 or the window assembly 250) by sending the appropriate signal to the control module 190. In various embodiments, this control signal may be generated in response to commands generated when a user actuates a button displayed on a graphical user interface displayed by an application or Internet browser, actuates a button on a remote control, issues voice commands, creates gestures, or causes an actuation in any other manner now known or developed hereafter.

In the depicted embodiment, the locking mechanism 171 is a U-shaped bar. The U-shaped bar includes a first end 172 and a second end 174 that extend from opposite sides of a central portion 176. The first end 172 includes engagement features 173 (e.g., protrusions) adjacent its distal end and is aligned with a first catch feature 163 included at the first end 162 of the central segment 160. Similarly, the second end 174 includes engagement features 175 (e.g., protrusions) adjacent its distal end and is aligned with a catch feature 165 included at the second end 164 of the central segment 160. Notably, in the depicted embodiment, the locking mechanism has a fixed length “L4” and, thus, the first end 172 and the second end 174 are constantly aligned with catch features 163 and 165. By comparison, although catch feature 163 and catch feature 165 are illustrated in alignment with the receiver 120 included in/on the first segment 110 and the receiver 140 included in/on the second segment 130, respectively, these features only move into alignment when the telescopic housing 106 moves into its expanded position P1. That is, catch features 163 and 165 and receivers 120 and 140 are included on the same portion of their respective segments (e.g., the top), but only move into alignment when the segments of the telescopic housing 106 are moved telescopically to bring these features into alignment.

In the depicted embodiment, the first catch feature 163 and the second catch feature 165 are through holes that extend from the interior compartment 166 through the exterior 167 of the central segment 160. Thus, catch features 163 and 165 allow the locking mechanism 171 to extend out of the central segment 160 and directly engage the receiver 120 on the first segment 110 and the receiver 140 on the second segment 130 when the telescopic housing 106 is in its expanded position P1. However, in other embodiments, catch features 163 and 165 might be or include any components that allow the locking mechanism 171 to selectively secure the central segment 160 to the first segment 110 and the second segment 130. That is, catch features 163 and 165 might be or include any components that allow the locking mechanism 171 to selectively “catch” segments 110 and 120. As one example, the catch features might be expandable components that expand when impacted to secure the locking mechanism 171 to receivers 120 and 140 (thereby securing central segment 160 in a fixed position with respect to the first segment 110 and the second segment 130) when the catch features 163/165 are aligned with receivers 120/140 and the locking mechanism 171 is exerting a force on the catch features 163/165.

Still referring to FIGS. 5 and 6, in the depicted embodiment, the locking mechanism is biased towards its actuated/biased position P3. Thus, if the telescopic housing 106 is moved to its extended position P1, the first end 172 and second end 174 of the locking mechanism 171 (the U-shaped bar) are pushed through catch feature 163 and catch feature 165, into receiver 120 and receiver 140, respectively. When ends 172 and 174 of the locking mechanism 171 move into engagement with receivers 120 and 140, the engagement features 173, 175 may engage corresponding engagement features included in receivers 120 and 140. For example, engagement features 173 and 175 may be male engagement features and receivers 120 and 140 may include corresponding female engagement features, or vice versa. In at least some of these embodiments at least one of the male or female engagement features may be deformable (e.g., detents) to allow the engagement features to form a releasable engagement that locks the locking mechanism 171 to receivers 120 and 140.

Thus, in the depicted embodiment, moving the telescopic housing 106 to its expanded position P1 automatically causes the locking mechanism 171 to move upwards to its biased position P3, insofar as upwards describes the motion with respect to the orientation shown in the figures and is not intended to limit the security bar to a particular orientation. To achieve this, the actuator 180 may include a base 182 with an actuatable component, such as a solenoid, a piston, a ballast chamber, etc., an engagement end 186, and an expandable or movable pin 184 that extends between the base 182 and the engagement end 186. A biasing member (e.g., spring) 185 is also wrapped around the movable pin 184 and is biased to push the engagement end 186 away from the base 182. Thus, until the locking mechanism 170 is actuated, the biasing member 185 biases the movable pin 184 so that it extends away from the base 182, forcing the engagement end 186 to press the locking device 171 upwards towards its unactuated or rest position P3. The upward force on the locking device 171 forces ends 172 and 174 through or into engagement with catch features 163 and 165 so that when the telescopic housing 106 moves to its expanded position P1 and aligns the catch features 163 and 165 with the receivers 120 and 140, the locking assembly 170 engages receivers 120 and 140 (see FIG. 5) and locks the security bar in its expanded position P1.

Then, after an actuation, the expandable or movable pin 184 moves or collapses into a position adjacent the base 182, moving the locking assembly 170 into its actuated position P4 (see FIG. 6). For example, a remote actuation (e.g., generated via an application on a smartphone) may cause the control module 190 to send an electrical impulse to a solenoid disposed in the base 182 which may generate a force that overcomes the biasing of the biasing member 185 and causes the engagement end 186 of the actuator 180 towards the base 182 of the actuator 180. Alternatively, the control module 190 may deliver gas or liquid to a piston disposed in the base 182 to cause the movable pin 184 to overcome the biasing of the biasing member 185 and move the engagement end 186 of the actuator 180 towards the base 182 of the actuator 180. Regardless, as the pin 184 moves downwards or collapses, the locking device 171 may move downwards, out of engagement with catch features 163 and 165 and/or receivers 120 and 140.

In some embodiments, when the control module 190 receives a remote actuation, the control module 190 may actuate the actuator 180 for a predetermined amount of time (e.g., 5 seconds, 10 seconds, or some amount of time in the range of approximately 1 second to approximately 5 or 10 minutes). This may unlock the security bar 100 for a predetermined amount of time, after which the security bar 100 may shift back into an automatic locking configuration (i.e., a configuration where the security bar 100 automatically locks when the telescopic housing 106 is in or moved into its expanded position P1). Alternatively, the control module 190 may actuate the actuator 180 indefinitely (e.g., leave the security bar 100 unlocked until a next actuation).

Notwithstanding the foregoing description of the locking assembly 170, in other embodiments, the locking assembly 170 can be or include any components that can free the central segment 160 to move with respect to the first end segment 110 and the second end segment 130. Additionally or alternatively, the locking assembly 170 can be or include any components that can lock the central segment 160 in a fixed position with respect to the first end segment 110 and the second end segment 130. That is, the locking assembly 170 can be or include any components that can lock or unlock the security bar 100 while the security bar 100 is in its expanded position P1. In embodiments where the locking assembly 170 locks the security bar 100 in its expanded position P1, the locking assembly 170 ensures that the telescopic housing has a fixed overall length OL1 until a subsequent actuation (e.g., an unlocking actuation). In some embodiments, the telescopic housing 106 may be able to be locked in (and unlocked from) various positions of various lengths, including its contracted position; however, once the telescopic housing 106 is locked in a particular position (i.e., once the telescopic housing 106 is locked into a particular length), the telescopic housing will be locked in that particular position (i.e., at that particular length) until a subsequent actuation.

As one example, in some embodiments, the first end segment 110 and/or the second end segment 130 may include a plurality of receivers 120/140 that allow the telescopic housing 106 to be locked in a plurality of discrete positions. As another example, in some embodiments, the central segment 160 may be an expandable segment and actuation of the locking mechanism 170 may cause the housing of the central segment 160 to expand and contract (e.g., expand/contract vertically and/or horizontally to increase the cross-sectional size of the central segment) and frictionally engage the first segment 110 and the second segment 130. In these embodiments, the telescopic housing 106 may be lockable in any position, from its shortest length (i.e., its most contracted position) to its longest length (i.e., its most extended position).

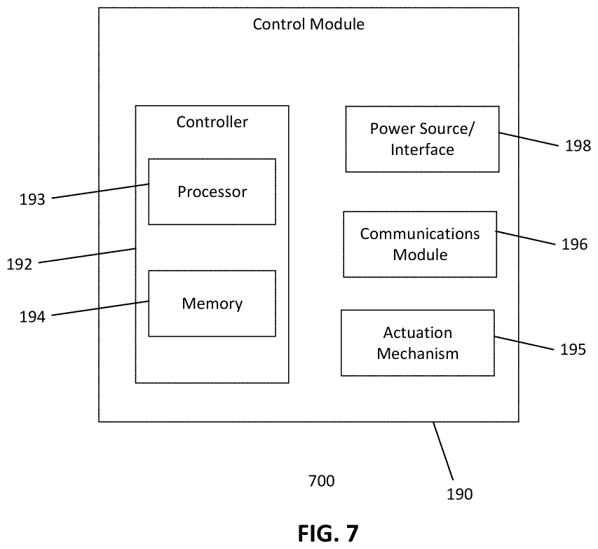

In FIG. 7, a block diagram 700 depicts an example embodiment of control module 190. As mentioned, generally, the control module 190 is configured to receive lock or unlock signals and cause actuations of the lock assembly 170 in response to these signals. To effectuate this, the control module may include a controller 192, an actuation mechanism 195, a communications module 196, and a power source/interface 198. At a high-level, the controller 192 is configured to process signals received by the communications module 196 (e.g., from a smartphone, home assistant device, etc.) and cause the actuation mechanism 195 to actuate the actuator in accordance with commands included in the signals (e.g., lock and unlock commands). The power source/interface 198, which, for example, may be batteries, provides power to the controller 192, the communications module 196, and the actuation mechanism 195.

More specifically, the controller 192 may include a processor 193 and a memory 194. While the figure shows a single block for processor 193, it should be understood that the processor 193 may represent a plurality of processing cores, each of which can perform separate processing. Meanwhile, memory 194 may include random access memory (RAM) or other dynamic storage devices (e.g., dynamic RAM (DRAM), static RAM (SRAM), and synchronous DRAM (SD RAM)), for storing information and instructions to be executed by processor 193. The memory 194 may also include a read only memory (ROM) or other static storage device (e.g., programmable ROM (PROM), erasable PROM (EPROM), and electrically erasable PROM (EEPROM)) for storing static information and instructions for the processor 193. In addition, the memory 194 may be used for storing temporary variables or other intermediate information during the execution of instructions by the processor 193. Although not shown, in some embodiments, the controller 192 may include a bus or other communication mechanism for communicating information between the processor 193 and memory 194.

The controller 192 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The controller 192 performs a portion or all of the processing steps of the invention in response to the processor 193 executing one or more sequences of one or more instructions contained in a memory, such as memory 194. Such instructions may be read into memory 194 from another computer readable medium. One or more processors in a multi-processing arrangement may also be employed to execute the sequences of instructions contained in memory 194. In alternative embodiments, hard-wired circuitry may be used in place of or in combination with software instructions. Thus, embodiments are not limited to any specific combination of hardware circuitry and software.

Put another way, the controller 192 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, or any other medium from which a computer can read.

Embodiments presented herein include software stored on any one or any combination of non-transitory computer readable storage media, for controlling the controller 192, for driving a device or devices for implementing the invention, and for enabling the controller 192 to interact with a human user (e.g., an end-user). Such software may include, but is not limited to, device drivers, operating systems, development tools, and applications software. Such computer readable storage media further includes a computer program product for performing all or a portion (if processing is distributed) of the processing presented herein. The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

Still referring to FIG. 7, the actuation mechanism 195 may be any component, software, or mechanism that can cause an actuation of the actuator 180. For example, in some embodiments, the actuation mechanism 195 may be configured to deliver electricity to a solenoid included in an actuator 180 in order to cause an actuation of the actuator 180. Alternatively, the actuation mechanism may deliver gas to a piston disposed in the actuator 180 in order to cause an actuation of the actuator 180.

Meanwhile, the communication module 196 may provide a two-way data communication coupling to any desirable electronic device, including smartphones, home assistants, and other such electronic devices. That is, the communications module 196 may provide data communication through one or more networks to other data devices. For example, the communications module 196 may provide connectivity to a smartphone. The connection may be through a “wired” communication channel or a wireless communication channel or protocol, such as BLUETOOTH®, or any other known form of wireless communication, such as optical communication, ultrasonic communication, and near-field communication.

As mentioned, the power source/interface 198 provides power to the controller 192, the communications module 196, and the actuation mechanism 195. The power source/interface 198 may include any components that generate, rectify, convert, etc. electricity in order to power these components. As one example, the power source/interface 198 may be two AA batteries. Alternatively, the power source/interface 198 may be a USB port that allows power to be delivered to the control module 190 via a wired connection between the USB port and an outlet.

Finally, although not shown, in some embodiments, the control module 190 may also include additional components, such as a camera configured to provide surveillance video or images, a button to allow for manual actuations (e.g., locking or unlocking) of the security bar 100, and any other such features. Additionally, although not shown, the central segment may include a removable panel or access panel so that various components of the control module 190 can be accessed for service or replacement.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the security bar described herein, or portions thereof may be fabricated from any suitable material or combination of materials, such as plastic, foamed plastic, wood, cardboard, pressed paper, metal, supple natural or synthetic materials including, but not limited to, cotton, elastomers, polyester, plastic, rubber, derivatives thereof, and combinations thereof, provided that, overall, the security bar 100 is a force resistant security bar sufficient for securely locking a door or window. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Finally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

1. A security bar comprising:
an expandable housing that is movable between a contracted position and an expanded position; and
a locking assembly that is remotely actuatable, the locking assembly being disposed within the expandable housing and being configured to unlock the expandable housing from the expanded position in response to a remote actuation.

2. The security bar of claim 1, wherein the locking assembly is disposed entirely within the expandable housing.

3. The security bar of claim 1, wherein the expandable housing is telescopic and comprises:
a central segment;
a first end segment disposed on a first side of the central segment; and
a second end segment disposed on a second side of the central segment.

4. The security bar of claim 3, further comprising:
one or more grip members disposed on at least one of: (1) an exterior end of the first end segment; and (2) an exterior end of the second end segment.

5. The security bar of claim 3, wherein:
the first end segment includes one or more first receivers;
the second end segment includes one or more second receivers; and
the locking assembly is disposed within the central segment and includes a locking mechanism that selectively engages one of the one or more first receivers and one of the one or more second receivers to lock the expandable housing at a specific overall length.

6. The security bar of claim 3, wherein the first end segment and the second end segment move independently with respect to the central segment.

7. The security bar of claim 3, wherein the first end segment and the second end segment move in synchronization with respect to the central segment.

8. The security bar of claim 1, wherein the expandable position is a first expandable position and the expandable housing is movable between and lockable in a plurality of discrete expandable positions.

9. The security bar of claim 1, wherein the expandable housing can span a window frame or door frame when in the expanded position.

10. The security bar of claim 1, wherein the locking assembly is biased towards an actuated position so that the expandable housing automatically locks into the expanded position upon being moved into the expanded position.

11. The security bar of claim 10, wherein the remote actuation unlocks the expandable housing from the expanded position for a predetermined amount of time before biasing of the locking assembly relocks the expandable housing in the expanded position.

12. The security bar of claim 1, wherein the remote actuation is a first remote actuation and a second remote actuation relocks the expandable housing in the expanded position, the expandable housing remaining unlocked between the first remote actuation and the second remote actuation.

13. The security bar of claim 1, wherein the locking assembly comprises:
a locking mechanism;
a control module; and
an actuator that is configured to actuate the locking mechanism from a rest position to an actuated position when the control module receives a command to lock or unlock the security bar.

14. The security bar of claim 13, wherein the locking mechanism comprises a U-shaped bar and the expandable housing includes two or more receivers that the U-shaped bar can engage when in the actuated position to lock the expandable housing in the expanded position.

15. The security bar of claim 14, wherein a first end of the U-Shaped bar and a second end of the U-shaped bar each include catch features that releasably secure the U-shaped bar to two of the two or more receivers.

16. The security bar of claim 13, wherein the actuator includes a base that is secured to the expandable housing, an engagement end that is secured to the locking mechanism, and a movable pin that can move the engagement end towards and away from the base to move the locking mechanism between the rest position and the actuated position.

17. The security bar of claim 16, further comprising a biasing member, the movable pin being configured to overcome a biasing force of the biasing member to move the locking mechanism to the actuated position.

18. The security bar of claim 1, further comprising:
a control module configured to receive the remote actuation from a remote electronic device and actuate the locking assembly in response the remote actuation.

19. A window assembly comprising:
a window frame
a first window that is movable within the window frame;
a second window that is movable within the window frame; and
a security bar extending linearly over the first window, between the second window and the window frame, the security bar being remotely actuatable to lock or unlock the second window for linear movement within the window frame, the security bar moving linearly to extend or collapse as the second window moves within the window frame.

20. A door assembly comprising:
a door frame
a first door that is movable within the door frame;
a second door that is movable within the door frame; and
a security bar extending linearly over the first door, between the second door and the door frame, the security bar being remotely actuatable to lock or unlock the second door for linear movement within the door frame, the security bar moving linearly to extend or collapse as the second door moves within the door frame.
